(19) United States
(12) Patent Application Publication
(10) Pub. No.: US 2009/0093221 A1
(43) Pub. Date: Apr. 9, 2009

(54) METHOD AND APPARATUS FOR SIGNALING INTERFERENCE INFORMATION FOR MULTI-USER MIMO

(75) Inventors: Kyle Jung-Lin Pan, Smithtown, NY (US); Donald M. Grieco, Manhasset, NY (US); Erdem Bala, Farmingdale, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/233,902

(22) Filed: Sep. 19, 2008

Related U.S. Application Data
(60) Provisional application No. 60/978,170, filed on Oct. 8, 2007.
(60) Provisional application No. 60/982,866, filed on Oct. 26, 2007.

(51) Int. Cl. H04B 1/02

(52) U.S. Cl. 455/101

(57) ABSTRACT

A method and apparatus for signaling interference information in a multi-user multiple-input multiple-output (MU-MIMO) system including a plurality of wireless transmit/receive units (WTRUs) and a base station are disclosed. The method includes the base station signaling interference information including rank information or a number of WTRUs to a particular WTRU based on beamforming vector feedback information received from the WTRUs. In order to reduce the downlink signaling overhead, confirmation of the beamforming vector feedback from WTRUs is used. The interference beamforming vectors and rank information or the number of WTRUs can be signaled separately or jointly.

### CROSS REFERENCE TO RELATED APPLICATIONS

This application claims the benefit of U.S. Provisional Application No. 60/978,170 filed Oct. 8, 2007, and U.S. Provisional Application No. 60/982,866 filed Oct. 26, 2007, which are incorporated by reference as if fully set forth.

### FIELD OF INVENTION

This application is related to wireless communications.

### BACKGROUND

Long term evolution (LTE) for the third generation partnership project (3GPP) includes many improvements to radio interfaces and network architecture of a wireless communication system 100 including at least one base station 105 and a plurality of wireless transmit/receive units (WTRUs) 110₁, 110₂ and 110₃, as shown in FIG. 1. This includes specifications for an evolved universal terrestrial radio access (E-UTRA) network.

Efficient signaling for interference information in a multi-user multiple-input multiple-output (MU-MIMO) system is important to an E-UTRA. Availability of interference information for a WTRU improves MIMO link and system performance, and increases spectrum efficiency.

Signaling overhead may be a problem with MU-MIMO, particularly when interference information from other WTRUs is needed for a given WTRU. Additional signaling is required to communicate the interference information to the given WTRU.

### SUMMARY

A method and apparatus for signaling interference information in a MU-MIMO system including a plurality of WTRUs and a base station are disclosed. The method includes the base station signaling the interference information including rank information or a number of WTRUs to a particular WTRU based on beamforming vector feedback information received from the WTRUs. In order to reduce the downlink signaling overhead, confirmation of the beamforming vector feedback from the WTRUs is used. When beamforming vector feedback information from a particular WTRU is confirmed by the base station, a positive acknowledgement (ACK) or a beamforming message indicating positive confirmation of the WTRU's beamforming feedback information is sent along with the interference information to the particular WTRU from the base station. When beamforming vector feedback information from a particular WTRU is not confirmed by the base station, a negative acknowledgement (NACK) or a beamforming message indicating negative confirmation of the particular WTRU's beamforming feedback information is sent along with the interference beamforming information to the particular WTRU from the base station. The interference beamforming vectors and rank information or the number of WTRUs can be signaled separately or jointly.

### BRIEF DESCRIPTION OF THE DRAWINGS

A more detailed understanding may be had from the following description, given by way of example in conjunction with the accompanying drawings wherein:

FIG. 1 shows a conventional wireless communication system including a base station and a plurality of WTRUs;

FIG. 2 shows a table of possible combinations of beamforming vectors for different numbers of users (WTRUs) scheduled for simultaneous transmission in the same frequency/time resource;

FIG. 3 shows a table that indicates the required number of bits for signaling the index of interfering vectors when the own (desired) beamforming vector is known;

FIG. 4 shows a table that indicates the required number of bits for signaling the interfering vectors and rank when the own (desired) beamforming information is known;

FIG. 5 is a block diagram of a WTRU; and

FIG. 6 is a block diagram of a base station.

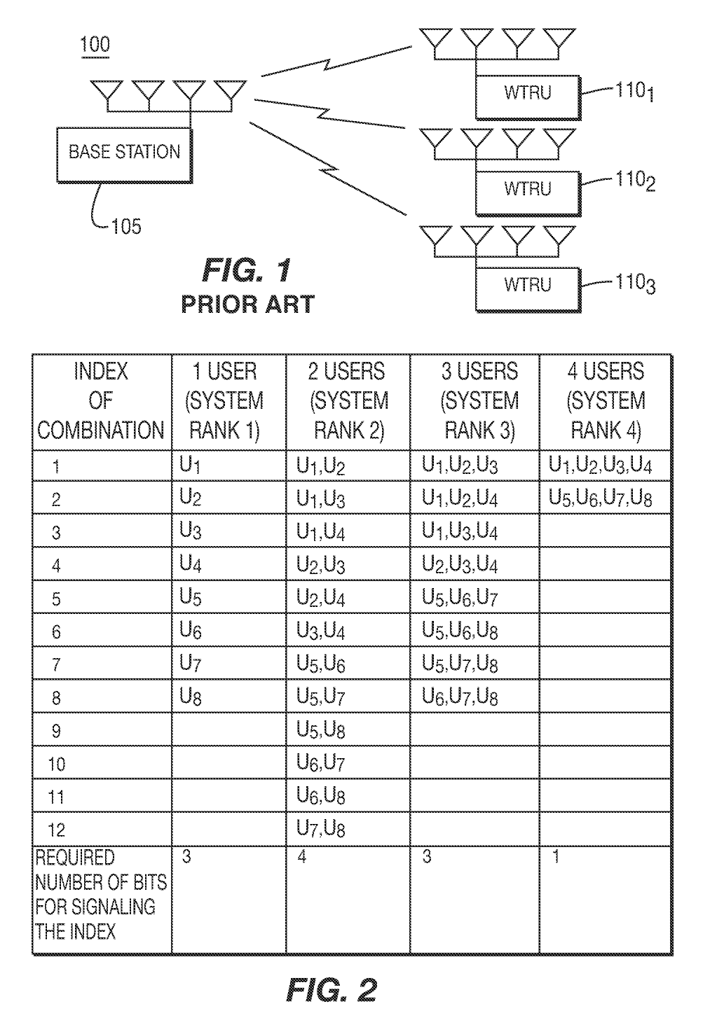

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment.

When referred to hereafter, the terminology “base station” includes but is not limited to a Node-B, a site controller, an access point (AP), or any other type of interfacing device capable of operating in a wireless environment.

Interference information regarding other WTRUs may be signaled to a WTRU when a desired beamforming vector is known by the WTRU. This may include the use of a codebook that includes a number of vectors. By way of example, eight vectors may be used.

Referring to the table of FIG. 2, shown is a MU-MIMO codebook consisting of 8 vectors (U₁, . . . , U₈). Assume that vectors U₁, U₂, U₃ and U₄ can form a unitary matrix and vectors U₅, U₆, U₇ and U₈ can form another unitary matrix. Then, if grouping using a unitary approach is applied, vectors U₁, U₂, U₃ and U₄ are grouped into one group M₁. Similarly, vectors U₅, U₆, U₇ and U₈ are grouped into a second group M₂. The grouping of the vectors may be based on a unitary rule. Other rules may be applied, e.g., a non-unitary approach with a correlation threshold, whereby the, vectors are grouped based on the correlation level between them. If the correlation level between vectors is below a predetermined threshold, then the vectors can be grouped together. No rule may also be used, (i.e., no restriction is used), when vectors are grouped, whereby vectors can be grouped in any possible way without any restriction as long as it is desired.

If no rule is used for grouping, there will be more vector combinations than if rules for grouping are applied. This is because when a rule is applied, there are more restrictions in combining vectors. If a unitary rule is applied, as shown in the table of FIG. 2, the vectors are combined within the same group, M. More specifically, U₁, U₂, U₃ and U₄ may be combined together within group M₁, and U₅, U₆, U₇ and U₈ may be combined together within group M₂. Combinations of beamforming vectors used with different numbers of WTRUs using the unitary approach are shown in FIG. 2. For example, when two WTRUs are scheduled for transmission and they are assigned two different vectors from group M₁, there are (4, 2)=6 possible combinations. The same is true when the vectors are selected from group M₂. Therefore, the total number of combinations is 12.

As shown in the table of FIG. 2, the largest number of combinations occurs with two WTRUs. Therefore, all possible combinations can be indicated with log₂(12)=4 bits. If unitary preceding is used with a codebook of size 8, all the beamforming vectors can be signaled using 4 bits in the downlink as long as the number of WTRUs is given.

According to the table of FIG. 2, using one or two bits to indicate the desired beamforming vector is necessary. For example, one bit may be needed to signal the desired beamforming vector within a selected vector combination, and four additional bits may be needed to indicate the selected combination among the 12 vector combinations when there are two WTRUs. This requires a total of five bits to signal both desired and interfering beamforming vectors for two WTRUs. For three WTRUs, two bits may be needed to signal the desired beamforming vector within the selected vector combination, in addition to three bits to indicate the selected combination among eight possible combinations. For four WTRUs, two bits may be needed to signal the desired beamforming vector within the selected vector combination, in addition to one bit to indicate the selected combination among two combinations. This requires five, five and three bits in total to signal both desired and interfering beamforming vectors for 2, 3 and 4 WTRUs cases of the table of FIG. 2, respectively. Note that 2 bits are also needed to signal the number of WTRUs.

However, if the desired beamforming vector is known to the WTRU, signaling all the possible combinations in the table of FIG. 2 may not be necessary. An assumption can be made that the desired beamforming vector may be known to WTRU. Such an assumption can be made if the beamforming/precoding confirmation scheme is used. Therefore, an efficient method of signaling interference information using a small subset of the combinations in the table of FIG. 2, when the desired beamforming vector is known, is disclosed below.

One technique for helping the WTRU know a desired beamforming vector is by using a one-bit indicator, (i.e., a positive acknowledgement (ACK)), to inform a WTRU that the beamforming vector fed back by WTRU is used at base station. This technique operates as follows. A WTRU feeds back the beamforming vector and receives an ACK from a base station. The WTRU then knows that the desired beamforming vector is exactly the same as the one it feeds back. In a MU-MIMO system, if K is the number of WTRUs in the system, a base station sends a one-bit indicator to each WTRU to respond to each WTRU's feedback of the desired beamforming vector. If the beamforming vector is the same for both the base station and the WTRU, (say the k-th WTRU), the base station sends a one-bit indicator, (which can be denoted by PMI_IND^{(k)} as an example), representing an ACK to the k-th WTRU. If the beamforming vector is not the same for the base station and the k-th WTRU, the base station sends a one-bit indicator (PMI_IND^{(k)} representing a negative acknowledgement (NACK) to the k-th WTRU. The base station may also send a beamforming vector of the k-th WTRU, (which can be denoted by PMI^{(k)} as an example), to the k-th WTRU. Alternatively, a bits-combination or one state can be used to indicate either an ACK or a NACK.

An ACK may be sent to respond to the WTRU as feedback if, for example, the base station does not override the WTRU's feedback and the feedback signal is reliable, (for example no error occurs in feedback signal). A NACK may be sent to respond to a WTRU's feedback if, for example, the base station overrides the WTRU's feedback or a WTRU feedback signal is not reliable.

When a WTRU receives an ACK from a base station for its feedback signal, the WTRU then knows the value of the desired beamforming vector. Therefore, only interference information needs to be sent to the WTRU.

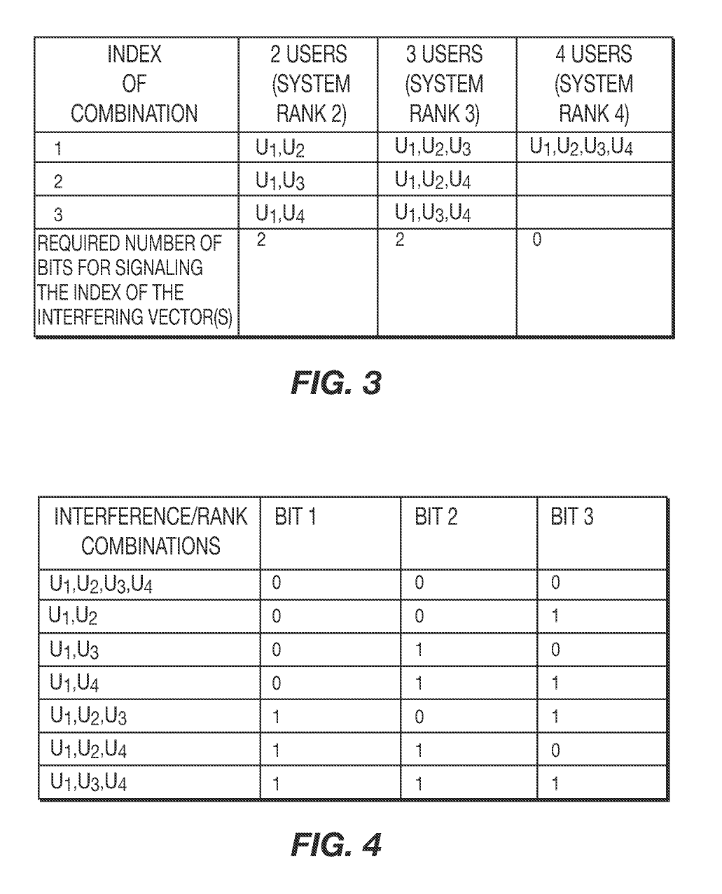

Referring to the table of FIG. 3, assuming that the WTRU knows the desired beamforming vector value, (e.g., U₁), because a one-bit indicator (carrying an ACK) is sent from the base station to the WTRU, the combinations without the desired beamforming vector U₁ may be excluded from the combinations in the table of FIG. 2, and the table of FIG. 3 can be generated so that it has the combinations containing only U₁. The number of possible combinations is reduced as shown in FIG. 3.

For example, by comparing the table of FIG. 3 to the table of FIG. 2, it can be seen that the number of possible combinations is reduced to 3, 3 and 1, from 12, 8 and 2 for system ranks 2, 3 and 4, respectively, whereby the system ranks indicate the number of users (i.e., WTRUs). Therefore, the number of bits needed to communicate interference information is reduced. The number of bits needed to communicate interference beamforming vectors is reduced to 2 bits, 2 bits, 0 bits (in FIG. 3) from 4 bits, 3 bits and 1 bit (in FIG. 2) for system ranks 2, 3 and 4, correspondingly. Accordingly, the signaling overhead is reduced.

In summary, one bit used as an indicator representing either an ACK or a NACK, is sent to the desired WTRU. Let b1=the number of bits used to signal interference information. If the indicator indicates an ACK, which means the desired beamforming vector is known to the WTRU, then two bits (b₁=2) are used to signal the interference information to the desired WTRU. It should be noted that the two bits to signal the interference are for illustration purposes of a codebook size of 8. The number of bits changes appropriately for different size of codebook, and the like.

In a second scheme, the interference information is signaled when the desired beamforming vector is unknown to the WTRU. While this scheme can be applied to any codebook that consists of any number of vectors, for illustration purpose eight vectors are used in the following description. In this scheme, one bit may be used as an indicator, representing either an ACK or a NACK, to the desired WTRU. If a one bit indicator indicates a NACK, (indicating that the desired beamforming vector is not known to the WTRU), then at most two bits (b₁=2) are used to signal the desired beamforming vector to the desired WTRU. Additional b₂=1, 3 or 4 bits are used to signal the interference information to the desired WTRU for the cases of 4 WTRUs, 3 WTRUs and 2 WTRUs respectively. The numerical value of b₂ depends on the design such as whether a subset restriction is used or a selection of vector combinations is used. According to this scheme, two or more control signaling formats are needed. Additionally, blind detection on control signaling format may also be required. It should be understood that the numbers b₁=2, b₂=2, 3 or 4 are for illustration purposes for a codebook size of 8. However, the numbers b₁, b₂ may be changed accordingly for a codebook of a different size, and the like.

In a third scheme, both the desired information and interference information are signaled when the desired beamforming vector is not known to the WTRU. While this scheme may be applied to any codebook that consists of any number of vectors, eight vectors are used for illustration purposes in the following description. According to this scheme, one bit is used as an indicator, representing either an ACK or a NACK, to the desired WTRU. If the one-bit indicator is used to signal a NACK, which means the desired beamforming vector is not known to the WTRU, then two bits (b₁=2) are used to signal the desired beamforming vector to the desired WTRU. Reference signals, such as dedicated reference signals, are used to signal the interference information to the desired WTRU. According to this scheme, only a single control channel format is needed. Blind detection on the interference information using a reference signal may be required. The number of bits used to signal the desired beamforming vector (b₁=2) is, for illustration purposes, of a codebook size of eight. The number b may change appropriately and accordingly for a codebook of a different size, and the like.

In a fourth scheme, both the desired information and interference information are signaled when the desired beamforming vector is not known to the WTRU. This scheme can be applied to any codebook that consists of any number of vectors. For illustration purposes, eight vectors are used in the following description. For example, one-bit is used for an indicator, representing either an ACK or a NACK, to the desired WTRU. If the one-bit indicator indicates a NACK, which means the desired beamforming vector is not known to the WTRU, then three bits (b₁=3) are used to signal the desired beamforming vector among eight vectors (U₁, U₂, . . . , U₈) to the desired WTRU. An additional two bits (b₂ =2), two bits (b₂ =2), and zero bits (b₂=0) for two WTRUs, three WTRUs and four WTRUs, respectively, are used to signal the interference information to the desired WTRU, (i.e., at most two bits are used to indicate the specific combination that contains interference vectors for up to three interfering WTRUs), as depicted in the table of FIG. 2. Note that the desired beamforming vector in the table of FIG. 2 is shown to be U₁ as an example. Multiple control channel formats may be needed in this scheme. Blind detection on control channel format may be required. The numbers b₁=3, and b₂=2, 2, 0, are for illustration purposes, of a codebook size of eight. The numbers b₁, b₂ are system parameters and change appropriately and accordingly for different size of codebook, and the like.

In a fifth scheme, both the interference beamforming vector and rank information are signaled when the desired beamforming vector is known to the WTRU. While this scheme may be applied to any codebook that consists of any number of vectors, eight vectors are used in the following description for illustration purposes. Accordingly, one bit is used for an indicator, representing either an ACK or a NACK, to the desired WTRU. If the one-bit indicator indicates an ACK, which means that the desired beamforming vector is known to the WTRU, then no bit is needed to signal the desired beamforming vector to the desired WTRU. An additional three bits (b₂=3) are used to signal the interference and rank information to the desired WTRU, three bits to indicate the specific combination among seven combinations, in the table of FIG. 3, assuming U₁ is the desired beamforming vector. According to this scheme, multiple control signaling formats may be needed. Blind detection on control channel format may be required. The number of bits needed for signaling (e.g., b₂=3) is for illustration purposes for a codebook size of eight. The actual number of bits is a system parameter and changes appropriately for a code book of different size, and the like.

In a sixth scheme, the desired and interference beamforming vectors and rank information are signaled when the desired beamforming vector is not known to the WTRU. While this scheme may be applied to any codebook that consists of any number of vectors, for illustration purpose, eight vectors are used in the following description. According to this scheme, one bit is used as an indicator, representing either an ACK or a NACK, to the desired WTRU. If the one-bit indicator indicates a NACK, which means the desired beamforming vector is not known to the WTRU, then three bits (b₁=3) are used to signal the desired beamforming vector among the eight vectors (U₁, U₂, . . . , U₈) to the desired WTRU. An additional three bits (b₂=3) are used to signal the interference and rank information to the desired WTRU, the three bits indicate the specific combination among seven combinations, as shown in FIG. 4, assuming U₁ is the desired beamforming vector. In this scheme, multiple control channel formats may be needed. Additionally, blind detection on control channel format may be required. The numbers b₁=3 and b₂=3 are for illustration purposes, of a codebook size of eight. The numbers b₁ and b₂ are system parameters and change appropriately and accordingly for different size codebooks, and the like.

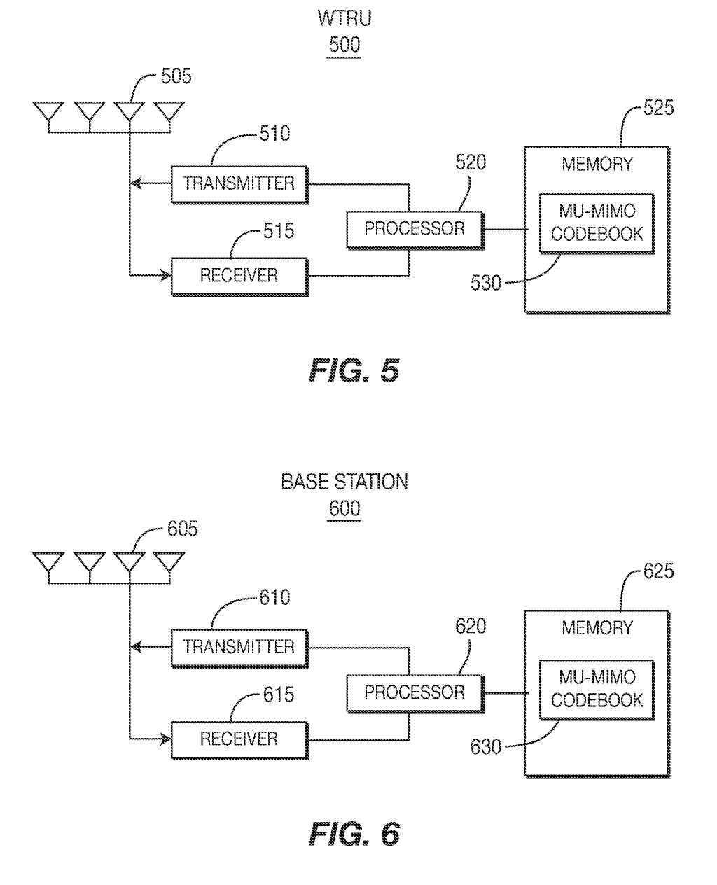

FIG. 5 is a block diagram of a WTRU 500 including a MIMO antenna 505, a transmitter 510, a receiver 515, a processor 520 and a memory 525. The memory 525 is configured to store a MU-MIMO codebook 530 including a plurality of beamforming vectors. The receiver 515 receives the beamforming/precoding confirmation indication, (e.g., in the form of ACK/NACK or confirmation message indicating positive/negative confirmation), the own (desired) beamforming information. (e.g., own beamforming vector index), and the interference beamforming information, (e.g., interference beamforming vectors indices received from other WTRUs). The processor 520 translates the beamforming indices, (own/interference), into beamforming vectors based on the codebook 530, as shown in FIGS. 2-4. The WTRU 500 also feeds back the preferred beamforming information (vector index) to a base station through the transmitter 510 and antenna 505.

FIG. 6 is a block diagram of a base station 600 including a MIMO antenna 605, a transmitter 610, a receiver 615, a processor 620 and a memory 625. The memory 625 is configured to store a MU-MIMO codebook 630 including a plurality of beamforming vectors. The transmitter 610 and the receiver 615 are coupled to the MIMO antenna 605. The processor 620 is coupled to the memory 625, the transmitter 610 and the receiver 515. The transmitter 610 is configured to signal interference information to a particular WTRU based on the MU-MIMO codebook 630, which may include indices of a plurality of different combinations of the beamforming vectors based on a number of WTRUs that are scheduled for transmission.

The beamforming vectors may be divided into groups to form a plurality of unitary matrices (or non-unitary matrices if desired), wherein a subset of the beamforming vectors are combined within each group such that there are no common beamforming vectors among the groups. In one example, when each group includes four beamforming vectors, two WTRUs including the particular WTRU may be scheduled for transmission, and there are six different possible combinations of the beamforming vectors for each group. In another example, three WTRUs including the particular WTRU may be scheduled for transmission, and there are four different possible combinations of the beamforming vectors for each group. In yet another example, four WTRUs including the particular WTRU are scheduled for transmission, and there is one possible combination of the beamforming vectors for each group.

The interference information may include four bits that indicate all possible combinations of the beamforming vectors. The interference information may include a plurality of bits that indicate all possible combinations of the beamforming vectors.

The receiver 615 may be configured to receive an indication from the particular WTRU that one of the beamforming vectors is a desired beamforming vector. The processor 620 may be configured to exclude the beamforming vector combinations without the desired beamforming vector from the possible combinations such that the number of bits needed to communicate the interference information is reduced.

The receiver 615 may be configured to receive a beamforming vector that is fed back from the particular WTRU. The transmitter 610 may be configured to transmit a positive indication (ACK) or a confirmation message indicating a positive confirmation to the particular WTRU to indicate that the fed back beamforming vector is a desired beamforming vector.

The receiver 615 may be configured to receive a beamforming vector that is fed back from the particular WTRU. The transmitter 610 may be configured to transmit a negative indication (NACK) or a confirmation message indicating negative confirmation to the particular WTRU to indicate that the fed back beamforming vector is not a desired beamforming vector.

The receiver 615 may receive beamforming vector index feedback from each of a plurality of WTRUs 500. The processor 620 determines the beamforming vector to be used for each of the WTRUs. The processor 620 may use the beamforming vector index fed back from each WTRU 500 and transmit a beamforming confirmation, (e.g., an ACK), to the WTRU 500 to confirm that the fed back beamforming vector is used at the base station 600. The processor 620 may also use a beamforming vector, other than the beamforming vector indicated by the vector index fed back from the WTRU 500, and transmit a vector index that is translated from the beamforming vector using the codebook 630 via the transmitter 610 and the MIMO antenna 605. In this case, the base station 600 may transmit a negative confirmation message, (e.g., a NACK), to the WTRU 500 to inform the WTRU 500 that beamforming vectors different than the beamforming vector fed back from the WTRU 500 is used at the base station 600.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method of signaling multi-user multiple-input multiple-output (MU-MIMO) signal interference information, the method comprising:
signaling interference information to a particular wireless transmit/receive unit (WTRU) using a MU-MIMO codebook including a plurality of beamforming vectors, wherein the MU-MIMO codebook includes indices of a plurality of different combinations of the beamforming vectors based on a number of WTRUs that are scheduled for transmission;
receiving a beamforming vector that is fed back from the particular WTRU; and
transmitting an indication to the particular WTRU to indicate whether or not the fed back beamforming vector is a desired beamforming vector.

2. The method of claim 1 wherein the beamforming vectors are divided into groups to form a plurality of unitary matrices, wherein a subset of the beamforming vectors are combined within each group such that there are no common beamforming vectors among the groups.

3. The method of claim 2 wherein when each group includes four beamforming vectors, two WTRUs including the particular WTRU are scheduled for transmission, and there are six different possible combinations of the beamforming vectors for each group.

4. The method of claim 2 wherein when each group includes four beamforming vectors, three WTRUs including the particular WTRU are scheduled for transmission, and there are four different possible combinations of the beamforming vectors for each group.

5. The method of claim 2 wherein when each group includes four beamforming vectors, four WTRUs including the particular WTRU are scheduled for transmission, and there is one possible combination of the beamforming vectors for each group.

6. The method of claim 1 wherein the interference information includes at least one bit that indicates all possible combinations of the beamforming vectors.

7. The method of claim 6 further comprising:
receiving an indication from the particular WTRU that one of the beamforming vectors is a desired beamforming vector; and
excluding the beamforming vector combinations without the desired beamforming vector from the possible combinations such that the number of bits needed to communicate the interference information is reduced.

8. The method of claim 1 wherein the indication transmitted to the particular WTRU is a positive acknowledgement (ACK) that indicates that the fed back beamforming vector is a desired beamforming vector.

9. The method of claim 1 wherein the indication transmitted to the particular WTRU is a negative acknowledgement (NACK) that indicates that the fed back beamforming vector is not a desired beamforming vector.

10. The method of claim 9 further comprising:
transmitting a desired beamforming vector to the particular WTRU.

11. The method of claim 9 further comprising:
transmitting additional bits to signal the interference information to the particular WTRU.

12. The method of claim 9 wherein dedicated reference signals are used to signal the interference information to the particular WTRU.

13. The method of claim 9 further comprising:
signaling the desired vector, interference beamforming vectors and rank information separately when the desired beamforming vector is not known to the particular WTRU.

14. The method of claim 9 further comprising:
signaling the interference beamforming vectors and rank information when the desired beamforming vector is known to the particular WTRU.

15. The method of claim 9 further comprising:
signaling the desired vector and jointly signaling the interference beamforming vector and rank information when the desired beamforming vector is not known to the particular WTRU.

16. A base station for signaling multi-user multiple-input multiple-output (MU-MIMO) signal interference information, the base station comprising:
a MIMO antenna;
a memory configured to store a MU-MIMO codebook including a plurality of beamforming vectors;
a transmitter coupled to the MIMO antenna, the transmitter being configured to signal interference information to a particular wireless transmit/receive unit (WTRU) based on the MU-MIMO codebook, wherein the MU-MIMO codebook includes indices of a plurality of different combinations of the beamforming vectors based on a number of WTRUs that are scheduled for transmission; and
a receiver coupled to the MIMO antenna, the receiver configured to receive a beamforming vector that is fed back from the particular WTRU, wherein the transmitter transmits an indication to the particular WTRU to indicate whether or not the fed back beamforming vector is a desired beamforming vector.

17. The base station of claim 16 wherein the beamforming vectors are divided into groups to form a plurality of unitary matrices, wherein a subset of the beamforming vectors are combined within each group such that there are no common beamforming vectors among the groups.

18. The base station of claim 17 wherein when each group includes four beamforming vectors, two WTRUs including the particular WTRU are scheduled for transmission, and there are six different possible combinations of the beamforming vectors for each group.

19. The base station of claim 17 wherein when each group includes four beamforming vectors, three WTRUs including the particular WTRU are scheduled for transmission, and there are four different possible combinations of the beamforming vectors for each group.

20. The base station of claim 17 wherein when each group includes four beamforming vectors, four WTRUs including the particular WTRU are scheduled for transmission, and there is one possible combination of the beamforming vectors for each group.

21. The base station of claim 16 wherein the interference information includes at least one bit that indicates all possible combinations of the beamforming vectors.

22. The base station of claim 21 wherein the receiver receives an indication from the particular WTRU that one of the beamforming vectors is a desired beamforming vector, the base station further comprising:
a processor coupled to the memory, the transmitter and the receiver, the processor being configured to exclude the beamforming vector combinations without the desired beamforming vector from the possible combinations such that the number of bits needed to communicate the interference information is reduced.

23. The base station of claim 16 wherein the indication transmitted to the particular WTRU is a positive acknowledgement (ACK) that indicates that the fed back beamforming vector is a desired beamforming vector.

24. The base station of claim 16 wherein the indication transmitted to the particular WTRU is a negative acknowledgement (NACK) that indicates that the fed back beamforming vector is not a desired beamforming vector.
